(19) United States
(12) Patent Application Publication
(10) Pub. No.: US 2002/0073217 A1
(43) Pub. Date: Jun. 13, 2002

(54) Method and apparatus for facilitating communication between a wireless device and disparate devices or systems

(76) Inventors: David Yin-Shur Ma, San Jose, CA (US); Jack Jian Chen, Palo Alto, CA (US)

Correspondence Address: David R. Stevens, Stevens & Westberg LLP, Suite 201, 99 North First Street, San Jose, CA, 95113, US

(21) Appl. No.: 09/772,451

(22) Filed: Jan. 29, 2001

Related U.S. Application Data
(63) Continuation-in-part of application No. 09/733,312, filed on Dec. 8, 2000.

(51) Int. Cl. G06F 15/16

(52) U.S. Cl. 709/230; 709/246

(57) ABSTRACT

A method and apparatus is provided for facilitating communication between a wireless device, such as a PDA or a laptop computer and disparate devices or systems. A device is provided that is configured to receive and examine data packets transmitted between a wireless device and a device that communicates with a network. Based on information in the data packet, if the data packet is configured under a first protocol, the communication device is configured to filter out the certain data packets transmissions to particular wireless devices, such as PDAs. If the communication device is not configured under the first protocol, such as a laptop computer, the communication device is configured to transmit the all data packets destined for the wireless device.

### RELATED APPLICATIONS

This is a continuation in part of co-pending and commonly assigned U.S. patent application Ser. No. 09/733,312, entitled Method and Apparatus for Facilitating Communication between a Personal Data Assistant and a Computer, filed Dec. 8, 2000.

### BACKGROUND

The invention relates generally to communication with a wireless device such as a personal data assistant (PDA) and, more particularly, to a method and apparatus for communicating between a wireless and a disparate electronic device or system that communicates with a network.

A wireless device is generally a portable electronic device configured to receive, send and otherwise utilize information that exists in some electronic form. Wireless devices include laptop computers, PDAs, and other devices that are configured to communicate over a medium other than conventional physical wires. The means of communication give users the freedom to move the device to remote locations and still have the ability to use the device. The communication medium is simply air, through which signals may travel in different forms and according to different protocols. Different forms and protocols that are well known in the art of wireless communication include electronic signals such as amplitude modulated (AM) and frequency modulated (FM) signals. They may also include infrared signals sent by infrared transmitters and received by infrared receivers, and other forms of signals. Some wireless devices communicate via other types of signals such as cellular telephone signals, which may be sent using different protocols such as time division multiple access (TDMA), code division multiple access (CDMA), and other protocols. Communication systems exist that utilize combinations of these methods and protocols.

A PDA, for example, is generally a portable device configured to store data and perform basic functions for a user to view, receive, transmit, store and consume data. Different types of PDAs are well known in the consumer electronics industry and are currently in widespread use. One popular device is the Palm Pilot™, made by Palm™. This device runs on a specialized operating system, known as PalmOS™. Other PDAs may be configured under different operating systems, such as the WindowsCE™ and the PocketPC™ that run under operating systems that are developed and sold by Microsoft Corporation™. These PDAs may offer internal software applications such as an address book for keeping names and addresses, a calendar for keeping schedules and important dates, a notebook for keeping notes, an Internet application for accessing the Internet to send and receive E-mail and other services, specialized applications for communicating with other devices such as other PDAs, computer servers over a network and other applications.

Most conventional PDAs include the ability to communicate with a computer system via a network, such as an Ethernet. One method of performing such communication is to dial up a connection with a computer server that is connected to network via an infrared access point connected to a local area network, or LAN. Such a connection is known as a LAN access point, or LAP. A LAP may be configured as an infrared modem that can receive infrared signals sent by a PDA. The LAP may then relay the signals sent by the PDA to another device. The LAP typically is connected to a computer such as a computer server, to which the PDA communicates via the LAP. One protocol conventionally used to communicate with the server is well known in the art as the TCP/IP/PPP protocol. The TCP/IP/PPP header includes the TCP/IP protocol that is commonly used in network communications along with a PPP header, to aid in the wireless transmission. This is a protocol commonly used in the industry of wireless data communications. Unfortunately, the use of this protocol requires a great deal of computer processing power in order to perform a data transfer. As a result, the transfer of data between the server and the PDA can be cumbersome and slow.

PDAs typically include features that allow it to communicate with other devices, including land-based computers, other devices that communicate with data packets as well as other PDAs. Using a conventional system, the PDA application would typically open up a TCP connection with the remote computer by specifying the computer's Internet Protocol (IP) address or other identification. The operating system of the PDA then opens up a PPP connection using a communication configuration, such as a LAP, or, more specifically, an infrared modem. The communication operation requires a TCP/IP/PPP protocol data stack stored in the operating system of the PDA. This stack enables the PDA to generate data packets having TCP/IP/PPP headers associated with each packet. Such a header is standard protocol for communication between computers when interacting and sending data from one computer to another. This requires the use of the PDA's memory capacity, which may be a large burden on the PDA, especially since PDAs are typically small hand held devices. This burden is also a bit unreasonable, since the interaction between the PDA and the computer is typically not an interaction using reciprocal dialog, but merely an operation of uploading and downloading data packets.

Moreover, the protocol lays a tremendous burden on the microprocessor within the PDA, which is typically a small, specialized microprocessor, designed to perform particular tasks. In particular, the AHDLC encoding procedure, an encoding procedure well known in the art, and the CRC checksum procedure, another procedure well known in the art, are a large burden on the PDA's microprocessor. Such burdens lessen the ability of a PDA designer to keep the PDA device small, yet still have adequate processing power.

If the AHDLC encoding is used, a PPP header is required. The PPP connection is made by negotiating a communication protocol and channel between the PDA and the computer via the LAP. The CRC checksum operation, part of an error check procedure between devices, also requires a mathematical operation to be performed on each byte of the data packet being sent. This could be a large burden on the microprocessor, greatly slowing down the data transfer process. As a result, the extra burden of the TCP/IP/PPP protocol causes the PDA to be slow to process, transmit and receive data, and requires large memory storage and processing components, increasing the size and weight of the PDA. After the PPP negotiation and connection set-up with the connection is complete, the PDA is assigned an IP address. The PDA can then open a TCP connection with the computer.

Communications often break down, however, when a PDA tries to communicate with disparate devices. Given the limited processing power of conventional PDAs, simplified and universal communication protocols are preferred. Unfortunately, most disparate devices communicate according to communication protocols that are particular to certain devices.

For example, in a Microsoft Windows network environment, devices communicate according to WindowsCE™, a protocol that requires constant interaction with the system, which may be referred to as a CE system. In operation, a device within a CE system broadcasts a type of initiation packet to devices within the system. The broadcasts are part of a protocol known as NetBeui. The NetBeui protocol is a well-known protocol in the art of network design and operation. NetBeui may be embedded in the header of a data packet, typically within a TCP/IP header. For a packet transferred to a PDA, for example, the NetBeui protocol data is typically embedded in the header, where the header is usually configured under the TCP/IP/PPP protocol.

Devices outside the system that wish to communicate within the system may also receive these broadcasts. In response, a PDA or other device that wishes to communicate within the CE system sends a data packet to announce its presence in the system. This signal may also announce the PDA's desire to communicate with devices associated with the system. This process initializes the PDA with the system, setting up a communication protocol for exchanging data packets. This protocol includes a process of naming the outside device within the system, giving the device a unique ID for sending and receiving communications within the system. As known by those skilled in the art, this naming routine is a protocol that runs on top of the conventional TCP/IP protocol discussed above.

Typically, this announcing packet is broadcast to the entire system. In response to the PDAs packet, most every device within the system sends signals to the PDA. This would require a PDA to receive and respond to each and every packet transmitted to it. In a system having multiple devices, such a demand would be a great burden on a PDA. Moreover, such robust communication with the system is not necessary for the PDA. One reason for this highly interactive process performed by the system is to give the PDA a name within the system. In the normal course of communications, the CE System requires that a device have a name associated with it within the CE system to identify the initiating device for purposes of communicating within the system. PDAs typically do not require an ongoing session in order to communicate with a system, let alone every device in the system. A PDA only requires the ability to transmit packets between the PDA and the system, often asynchronously and typically only when necessary. Thus, it is not necessary for the PDA to have a name associated with the system, and, as a result, does not require this initialization either.

Therefore, it would be useful to develop a device and method for more efficiently transferring data between a PDA and a computer system that is less burdensome on the digital memory storage and the data processor of the PDA. As will be seen, the invention provides such a device and method that accomplishes these goals in an elegant manner.

### SUMMARY OF THE INVENTION

A method and apparatus is provided for facilitating communication between a wireless device, such as a PDA or a laptop computer and disparate devices or systems. A device is provided that is configured to receive and examine data packets transmitted between a wireless device and a device that communicates with a network. Based on information in the data packet, if the data packet is configured under a first protocol, the communication device is configured to filter out the certain data packets transmissions to particular wireless devices, such as PDAs. If the communication device is not configured under the first protocol, such as a laptop computer, the communication device is configured to transmit the all data packets destined for the wireless device.

### BRIEF DESCRIPTION OF THE DRAWINGS

Brief Description of the Drawings

FIG. 1 is a block diagram of a system for communicating between a wireless device such as a PDA and a computer according to the invention;

FIG. 2 is a block diagram of a PDA configured to operate according to the invention;

FIG. 3 is a block diagram of a communications interface according to the invention;

FIG. 4 is a block diagram of a computer configured to operate according to the invention;

FIG. 5 is a block diagram of a conventional data packet used for data communication;

FIG. 6 is a block diagram of a simplified data packet used according to the invention;

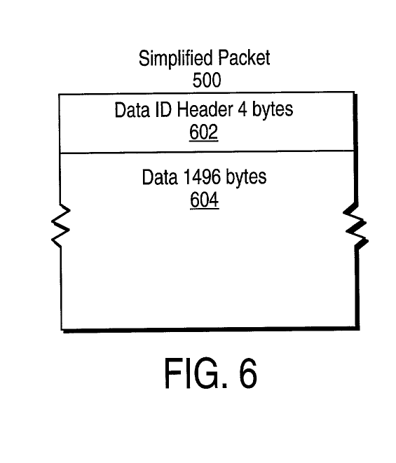

FIG. 7 is a flow chart of a process for transmitting data from a PDA to a network computer according to the invention; and

FIG. 8 is a flow chart of a process for transmitting data from a computer to a wireless device according to the invention.

### DETAILED DESCRIPTION OF PREFERRED EMBODIMENTS

The invention provides communication interface for enabling communicating between a wireless device such as a personal data assistant (PDA) and a device connected to or otherwise affiliated with a network such as computer server. A wireless device may be considered as a network compliant device if it is configured to receive and send communications that are necessary to communicate in a substantially continuous session with another network device. Examples of such devices are laptop computers and other such devices that carry on-going sessions with devices that are affiliated with the network, performing functions that may be common to a network device. Typical communication between certain wireless devices that may not be network compliant, such as a PDA, and other devices is not interactive and on-going, but rather involves relatively simple downloads and uploads of data packets. These data packets are also commonly transmitted between a PDA and another device asynchronously. This mode of operation does not require that the wireless device keep a substantial or continuous session of communication between the PDA and a network device. Therefore, according to the invention, complex identification protocols required for universal communication with other devices are not used, since they are not necessary. To this end, a communication interface is provided for filtering out or simply not allowing the transmission of these complex protocols to the wireless device. The communication interface in this mode, according to the invention, is acting as an interface between a wireless device, such as the PDA, and other conventional devices connected to a network. The communication interface may have an IP address, whether local or associated with the Internet, that is associated with the PDA so that it may enable data transmissions involving the PDA.

In one embodiment, a communication interface is provided for managing communication between a wireless device and a network device. The interface includes a receiver configured to receive data packets received by the communication device, the receiver including a signal receiver configured to receive a signal used for transmitting data over a medium and converter configured to convert the data signal into a form that can be stored. A transmitter may be included for transmitting data packets over a medium. A storage device configured to store data may also be included and may include a storage mechanism for storing data packets received by the receiver. The embodiment may also include an examining mechanism or analyzer configured to examine data packets transmitted between a wireless device and a network device, which may be configured to identify a data packet transmitted by a wireless device having indicia that indicates that the transmitting wireless device is configured according to a first protocol. The embodiment may also include a filter mechanism configured manage data transmissions between the wireless device and the network device. The filter means may be configured to subsequently relay data packets that are sent by a network device and that are configured according to the first protocol only to wireless devices that have transmitted such a packet having such indicia.

Depending on the particular embodiment, the communication interface may send and receive transmissions of data on its behalf, may be a pass-through device that filters out unnecessary communications originating from the network, or may otherwise govern communication between the PDA and devices connected to the network. This way, the PDA may communicate with a network without the need to engage in complex communication protocols. Such communication protocols may be required for devices that engage in ongoing communication sessions with other devices connected to the network. However, since typical PDAs only require the uploading and downloading of data packets, ongoing sessions are not required for a PDA's general functions. Therefore, communication protocols, such as device initiation protocols, are not required.

The invention is directed to address the problem of a PDA that may be exposed to a network environment that requires highly interactive communication protocols to communicate with one or more devices connected to a network. Since a typical PDA merely requires simply the uploading and downloading of data packets for its operation, such ongoing communication links and communication sessions are not necessary. Processes such as initiation protocols and other complex and highly interactive initiation processes may be obviated, greatly simplifying communications between a PDA and devices connected to a network environment. One example of such an environment is a Windows CE environment. In such an environment, the network requires that any device that wishes to communicate with other devices in the network be identified with a unique network ID. The process for establishing such an ID involves an ongoing session of sending and receiving data between the outside device and virtually every device on the network. The reason for such interaction is that the unique ID must not be the same as a network ID of a device that is established on the system. A network, by its nature, is a conglomeration of multiple devices that are configured to interact with each other according to a particular network's internal communication protocol. Although the network devices may be unique in their operation, they must conform to a communication protocol so that they may communicate. And, for communications purposes, although the devices must to some extent be homogeneous in their interactive operations with each other to ensure communication compatibility with each other, they must also retain a unique ID to distinguish their individual identities within the system. Hence, each device in the system must have a unique ID. As discussed in the background, the process is essentially an initiation process for establishing an outside device's ability to communicate within the network without interfering with other devices on the system. A user of a PDA that wishes to access such a system would be no exception.

According to the invention, a simplified data packet that may include a simplified header format for transferring and receiving data packets and a system that can communicate using the simplified format may be utilized. Such a configuration is described in co-pending U.S. patent application Ser. No. 09/733,312, filed Dec. 8, 2000, entitled Method and Apparatus for Facilitating Communication between a Personal Data Assistant and a Computer, which is commonly assigned to applicant and has a common inventor. According to the invention of the present invention, since complex and robust communication between a PDA and a device connected to a network, such a simplified data packet having a simplified header may be utilized. The simplified header may simply have basic information pertaining to the data being sent, such as size, sequence of data if transferred among a number of packets, destination address, identification of the communication interface, or different combinations and permutations of such information. A packet may be sent with simply a destination address and accompanying data. In using the simplified format, less memory capacity is required of the PDA as well as less processing capacity to prepare and send the data packets. An interface may be configured to communicate with PDA by receiving data from the PDA and sending data to the PDA under a simplified header format. The simplified format may be simplified relative to conventional TCP/IP/PPP header format, which may be required for a PDA to communicate with a device connected to a network. The interface may include a storage device for storing data and a wireless data transceiver for receiving data packets from and transmitting data packets to the PDA, where the data packets are configured under the simplified format. Accordingly, the PDA may include a similar transceiver configured to receive data packets from and transmit data packets to the interface.

According to the invention, the communication interface may be configured to communicate with a device connected to a network, such as a computer server, that is configured to send, receive and process data. The communication interface may act as a filter for filtering out unnecessary initiation communications destined for the PDA, preventing the overloading of the PDA with such communications.

In operation, the communication interface may receive the initiation communications from one or more devices connected to the network. A network environment such as Windows CE typically sends out the first packet, which is broadcast to the entire network. Outside Windows devices, which are devices that wish to be named within and be allowed to communicate with the Windows environment, would receive this packet and respond accordingly, initiating the naming protocol. As discussed above, the Windows naming operation runs on top of the TCP/IP protocol and operates to establish an internal name for the outside device so that it may communicate within the network. In contrast, and according to the invention, a PDA user may not wish to respond to such a broadcast, and remain sheltered from such communication. A communication device, according to the invention, would act as an intermediate communications module for filtering out such communications from the PDA.

In a preferred embodiment, the communications interface acts as an adaptive or learning filter that screens out different communications. The interface may be implemented in firmware that is connected to a particular network and that acts as an intermediary between the network and outside devices that are not configured to communicate within the network. As an adaptive or learning filter, the device may distinguish between PDAs and other devices and treat them differently. If the outside device is a Windows device, for example, the communications interface may simply allow the network to broadcast to the device, allowing the initiation process to begin, and allow a unique ID to be established for the device. In contrast, if the outside device is detected as a PDA, the communications interface may simply not relay these broadcasts to the PDA, in effect filtering them out.

The invention may include the utilization of dedicated processors, webservers configured to receive and route browser requests, application servers, state servers and other types of computer processors. These devices may be configured to communicate amongst each other and may be connected to one or more networks, including a Local Area Network (LAN), an intranet and the Internet. These networks may also include the use of wireless as well as wire line connections in order to communicate. However, it will be appreciated by those skilled in the art that such implementations of devices and systems are but few illustrations of the utility of the invention, and that the invention may have greater applicability and utility in many other applications where efficient routing and processing of data within one or more networks is involved. Equivalent structures embodying the invention could be configured for such applications without diverting from the spirit and scope of the invention. Although the embodiments described and illustrated herein are in the context of devices and systems for exchanging data among users of a computer system or network and users of PDAs, the invention extends to other applications where similar features are useful. The invention may include personal computers, application servers, state servers or Internet webservers that are designed and implemented on a computer and may be connected to a network for communication with other computers to practice the invention. A system configured to operate according to the invention may include a plurality of personal computers and PDAs connected to the Internet via individual modems or other communication means such as wireless communications.

The invention may also involve a number of functions to be performed by a computer processor, such as a microprocessor. The microprocessor may be a specialized or dedicated microprocessor that is configured to perform particular tasks by executing machine-readable software code that defines the particular tasks. The microprocessor may also be configured to operate and communicate with other devices such as direct memory access modules, memory storage devices, Internet related hardware, and other devices that relate to the transmission of data in accordance with the invention. In devices such as PDAs, it is important that processors are physically small enough to help keep the PDA itself small, yet powerful enough to be able to perform the tasks required to make the PDA useful for sending, receiving and using data. It is these goals that a device embodying the invention may achieve.

The software code utilized in the PDAs and other devices utilizing the invention may be configured using software fornats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention, which is defined by the appended claims.

Within the different types of devices, such as specialized computer servers and PDAs, that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by a central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. The invention is not limited to any particular type of memory device, nor any commonly used protocol for storing and retrieving information to and from these memory devices respectively. In devices such as PDAs, it is important that such memory devices are physically small enough to help keep the PDA itself small, yet contain enough storage space required to make the PDA useful for sending, receiving and using data. It is these goals that a device embodying the invention may achieve.

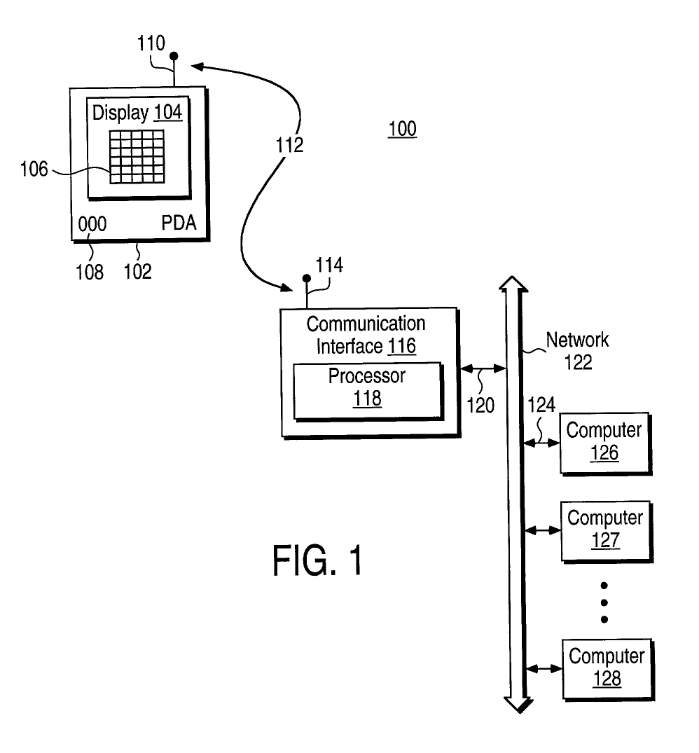

Referring to FIG. 1, a block diagram of a system having a device configured to enable communication between a PDA and a device connected to a network according to the invention is illustrated, in this embodiment a computer server connected to a network. The PDA 102 includes graphical user interface (GUI) 104 for displaying content 106 to a user. The PDA may also include manual control switches or knobs 108 for inputting data into the PDA, but may also be configured with a touch-sensitive screen or other type of data input mechanism for inputting data into the PDA. The PDA may also include means for transmitting and receiving data such as an antenna 110 connected to a transceiver (not shown in FIG. 1). Such an antenna may be internal to the device, not visible to a user during normal use. The transceiver may operate as a laser light device, a radio frequency (RF) device, or other type of communication mechanism configured to send and receive data between the PDA and some destination. The primary purpose of such a device is to provide a portable hand-held device for sending and receiving data between the PDA and another remote device.

The PDA may be configured to communicate via a signal 112 with a similar transceiver connected to an antenna 114, which is connected to communication interface 116. The interface transceiver may be configured to operate in the same manner as the PDA's transceiver. One purpose of the communication device is to provide a mechanism for enabling efficient and improved communication between the PDA and another device. This is accomplished by reducing the amount of data sent by and received from the PDA as well as the computations required for such data transactions in the normal use and operation of the PDA. The communication interface may include a processor 118 that may be configured to identify packets and their protocol and to manage header information that is transmitted between the PDA and the communication interface. One way that it may accomplish this is by reducing the amount of header data that is typically transferred to the PDA by reformatting and simplifying the conventional TCP/IP/PPP header to a smaller, efficient and more manageable header. This obviates the PDA's need to process and store the conventional header. According to the invention, since a PDA does not require an ongoing session within a network, such complicated communications protocols are not required.

The communication interface may also be configured to receive data that is transferred from the PDA in this simplified format, reducing the amount of header data transmitted by the PDA. As a result, this also reduces the amount of processing required by the PDA to transmit such data, such as the processing that is typically required to transmit data using conventional headers. This is described in more detail below. The common format for conventional data communications with PDAs is the TCP/IP/PPP protocol. When communicating between a PDA and a computer, the TCP/IP/PPP protocol is typically used. When communicating between a computer and other conventional devices, a TCP/IP is typically be used. This conversion may involve the conventional communication operations discussed above. One of the advantages of this configuration is that these operations can be performed by a communication interface connected to a network rather than the PDA, relieving the PDA of this burden.

Still referring to FIG. 1, the communication interface 116 may be configured to communicate through a communication channel 120 with a network 122. The communication channel may be a telephone landline, a specialized intranet connection, an Ethernet connection, or any number of communication mechanisms, whether constructed with electronic hardware or some type of wireless application. The Network may be a LAN, an intranet, the Internet, or some other type of mechanism that allows computers and other data processing devices to communicate amongst themselves. The network may also communicate via a second communication channel 124 with a computer 126, 127, 128. This allows a means for the communication interface to communicate with other devices that are connected to the network.

In operation, the PDA 102 may process data, convert the data into a signal 112 and transmit the signal to the communication device 116. The data is sent in separate packets, which may be of uniform or varying size. These packets may include a header having a predetermined format that is a specialized format configured to optimize the data transfer. The communication device may then convert the header format of the received data to a conventional TCP/IP header. This allows the data to be transferred along conventional channels, such as the network 122, to conventional devices, such as computer 126. The computer can then process the data and then return it along the reverse path back to the PDA.

This system optimizes the operation of the PDA in several steps. One step is to reduce the amount of transferred data packets to the PDA from the communication interface. As discussed in the background, conventional networks communicate using protocols that require a large amount of processing and transmitting of data. This processing also generates more data that must be transmitted along with the large header as well as the actual data. The communication interface takes this burden off of the PDA by filtering out data packets that are not necessary for PDA functions. The PDA can then communicate with other devices in remote locations, such as the computers 126, 127, 128. At this location, the computer is able to perform complex operations on the data. For example, a user of a PDA may want financial projections on a transaction. The user could send the basic information to the computer via the communication interface. The computer, having extensive processing power, could perform the complex operations and then transmit the result data back to the PDA via the communication interface for use by the PDA's user. These new features provided by the system effectively give virtually limitless remote processing and storage power to the PDA, and actually reduce the processing and data storage burden on the PDA at the same time by filtering out unwanted data packet transmissions.

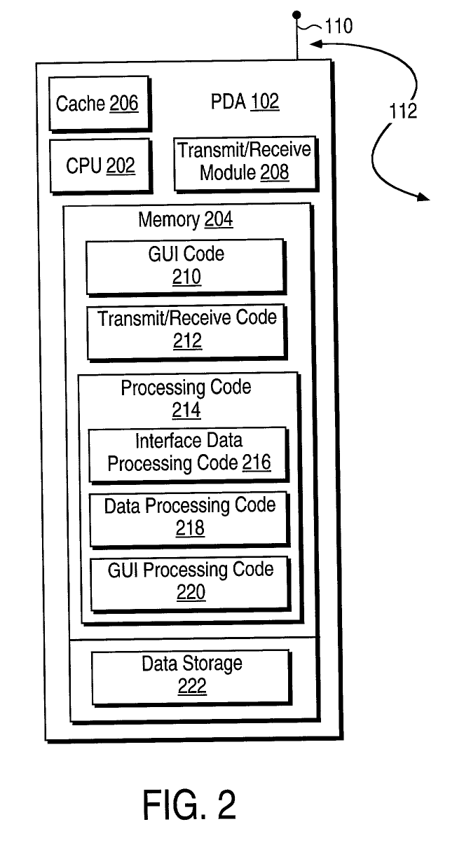

In order to understand the operation of the invention, it is useful to understand the components in more detail. Referring first to FIG. 2, a more detailed illustration of a PDA 102 is shown. The PDA typically includes a central processing unit (CPU) 202 that is configured to execute software commands and perform PDA functions according to the command instructions that may be received from an outside source. These commands may be stored in main memory 204 or cache memory 206. Such functions may include the transmission and reception of data, graphical user interface operations, data processing operations, data security functions, and other functions that may be related to the operation and use of a PDA. The PDA typically includes some type of transmit/receive module 208, which may be a transceiver that performs both sending and receiving operations, or separate components for transmitting and receiving data. The module may be connected to an antenna 110 for sending and receiving electronic signals 112.

The PDA may include a main memory 204 having software code and data stored therein. The software code may be executed by the CPU 202, and may govern the operations and functions of the PDA. The PDA may also include cache memory 206 for storing data frequently used by the CPU. In some applications, the PDA may be configured to store software from the main memory into the cache memory in order to give the CPU easier access to the data for execution. Graphical user interface code 210 may be executed by the CPU to control the PDA's display 104 (FIG. 1). The code used would likely be unique to the application used for the graphical display, such as a light emitting diode (LED) display, a quartz display, or other type of display. Many types and implementations of displays are well known to those skilled in the art of PDA design as well as other similar technologies. Transmit and receive code 212 may also be included in the PDA main memory. Upon execution by the CPU, the transmit and receive code enables the CPU to cause the PDA to transmit and receive data with the transmit and receive module 208. The memory may further include processing code 214 for processing instructions and data related to processing headers, data, GUI instructions and data, and other instructions.

The processing code may include interface data processing code 216 configured to change headers among different formats according to the invention. As discussed above, the invention provides a method and apparatus for optimized transmission of data between the PDA and a communication interface. The data is simply sent with minimal information. The header information may include the IP addresses of the PDA and the destination device for identifying the source and destination of the information. The header may also include the file name, the file size, the sequence of the data packet in relation to other data that has been sent, and other information related to the data, of different combinations and permutations of such information. Of course, the packet may also include the data itself, which may be referred to as payload data.

The header accompanying data within a packet may be configured according to a standard protocol such as the IrDA Object Exchange Standard, or IrOBEX, developed by the Infrared Data Association™. The invention, however, is not limited this protocol, but extends to other configurations that allow a data packet to be configured with limited header information. Such a data packet may include the minimal amount of information that is required to transmit data from the PDA to the communication interface, such as the name of the file being transferred and the beginning and end of the data.

For example, in the data transmission operation between the PDA and the communication interface, a first packet may be sent that identifies the name and size of the data file to be transferred. A second packet may then be sent having a header that identifies what part of the whole file is being transferred and the size of the particular portion being transmitted within the second packet, specifying the beginning and the end of the portion being transferred. However many packets that are needed to transfer the data are transmitted until the entire file has been completely transferred. The final packet may then specify the end of the file, indicating that the entire packet has been transferred to the destination. The transmission of data in this manner may be done in both directions, from the PDA to the communications interface as well as from the communications interface to the PDA. In either case, the transmission of data is greatly simplified in order to lighten the processing load on the PDA. This method also reduces the amount of storage space is needed in the PDA and greatly reduces the transmission time of data transmissions. This also relieves the PDA from having to keep a TCP/IP/PPP protocol stack in its memory.

Still referring to FIG. 2, the PDA may also include data processing code 218 stored in its main memory 204 for performing the processing of data within the PDA when the CPU executes the code. According to the invention, many data processing functions such as Windows naming protocols may be avoided by not relaying the naming data packets to the PDA, sparing it of the processing burden. This allows the PDA to run more efficiently and require less powerful processing circuitry. The PDA memory may also include GUI processing code for performing general GUI functions when executed by the CPU. The main memory may also include data memory for storing data to be used or transmitted by the PDA.

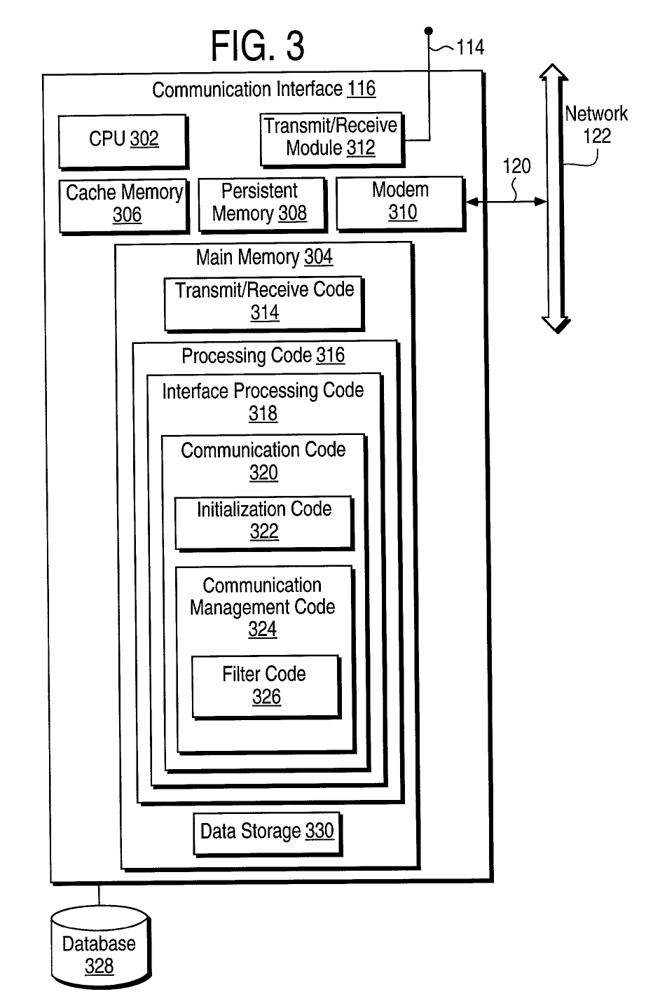

Referring to FIG. 3, further details of the communications interface 116 are shown. The interface may include a CPU 302 configured to execute software code stored in main memory 304 for performing internal operations of the interface. Optional cache memory 306 and persistent memory 308 may also be included in the interface to provide alternative storage locations to optimize access to data by the CPU. The interface may also include modem 310 that allows the interface to communicate with network 122 via communication link 120 as discussed above. This enables communication with other devices on the network such as computer 126 of FIG. 1. Transmit and receive module 312 may also be included for facilitating communication between the interface and the PDA, and the module may be connected to antenna 114. The module may be a transceiver, performing both transmit and receive functions, or the two functions may be divided into two separate modules. The transmission module may be a radio frequency module, configured to send and receive RF signals. The module may also be an infrared LAN (local area network) access point (LAP) for receiving and sending infrared signals when communicating with a similarly equipped and configured PDA. The invention is not limited to a particular type of interface between the PDA and the communication interface.

The interface includes a main memory 304 for providing main storage of data and software code required for the operation of the interface. Transmit code 314 may be included to allow the interface to perform transmit and receive functions when the code is executed by the CPU. The code can be designed to configure the interface to sent and transmit data having a simplified header, without any TCP/IP/PPP headers, with similarly configured PDAs.

The interface may also include processing code 316, which, according to the invention, configures the CPU to perform data processing and instruction execution when the CPU executes the code. The code may include interface processing code 318. The processing code includes executable software code for performing the management of data packets. These configurations may be used in facilitating communication between the PDA and the computer. Communication code 320 is configured to process headers of data packets by configuring them with the proper format according to the intended destination of the data packet.

For example, a data packet originating from the PDA and destined for the computer may have a simplified header as discussed above. The CPU may reconfigure this data packet when it executes the PDA initialization code 322. This code would allow the CPU to separate the data from the header so that it can be examined. The communication management code 324, which may be referred to as a communication manager application, or simply a communication manger, is configured to manage the communications between network devices and wireless devices that wish to communicate with each other. The filter code 326 may be within the management code and configured to filter out certain data packets that may be destined for all computers on the network by a broadcast or multicast transmission, or that may be a unicast transmission to a particular wireless device. If any particular packet or group of packets is undesirable to a particular wireless device, it can be filtered out, or simply not relayed to the device. One such example is the filtering out of a naming data packet or packets that are used in Windows network environments from transmission to PDAs.

Similarly, a data packet may originate from a computer 126 and destined for the PDA 102. Filter code 326 would then be configured to examine the data and determine whether and where to forward the data packet. If the proposed destination is a PDA, it is next determined whether the PDA has authorized such a transmission. If not, it is not relayed to the PDA. If however the destination is a wireless device that has authorized the transmission, then it is forwarded to the wireless device.

The computer, 126, FIG. 1, may be any type of data processing device such as a personal computer, wireless data communication device, or any other device that communicates by sending data packets configured with headers having TCP/IP format. A PDA may be able to communicate with such computers via the communication interface without having to deal with TCP/IP and TCP/IP/PPP header format operations.

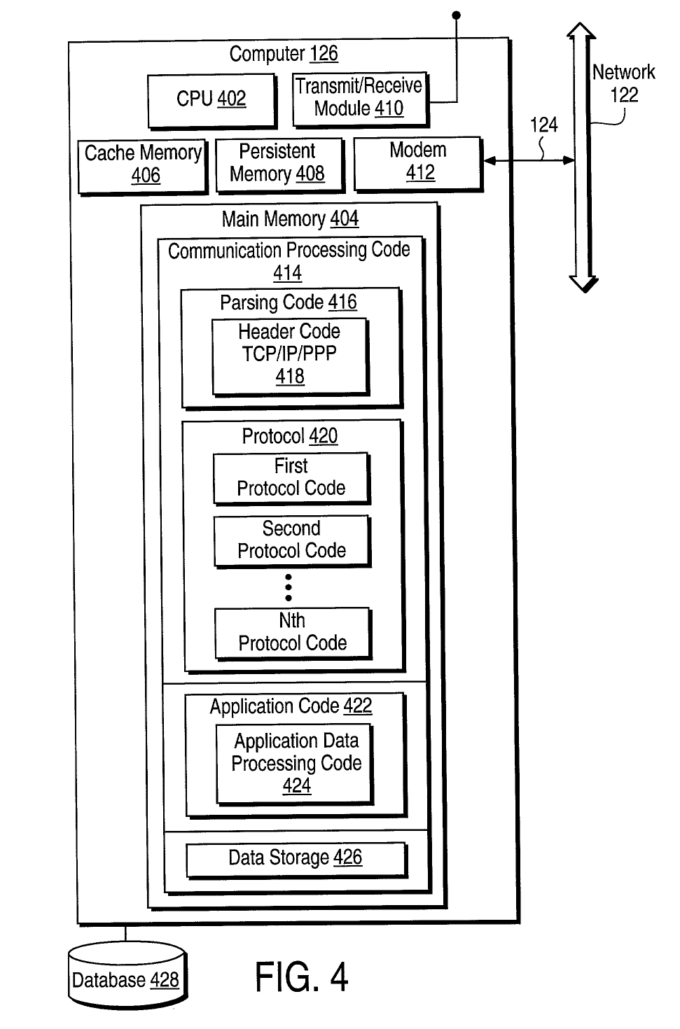

Referring to FIG. 4, a more detailed block diagram of a computer is shown. The computer may include a CPU 402 configured to perform standard processing operations of the computer when it executes software stored in main memory 404. The computer may also include cache memory 406 and persistent memory 408 for providing more efficient access to data and command instructions to the CPU for execution.

In an alternative embodiment of the invention, the computer may include the functions of the communication interface 116. The computer would then include substantially all of the processing code 316 and transmit and receive code 314, FIG. 3. The computer would then need a transmit and receive module 410 for communicating with the PDA in the same manner as the communication device 116 does with its transmit and receive module 312. In such a configuration, the communication interface is built in to the computer, obviating the need for a separate device. The computer would then be able to perform the data packet management functions by executing the communication management code 324, and may also perform the filtering functions by executing the filter code 326.

The computer may further include data processing code 414 that includes code that configures the CPU to perform data processing tasks. The code includes parsing code 416. The parsing code may cause the header to be parsed out from a data packet when the CPU executes the TCP/IP header code 418. Data may also be parsed out from a data packet by executing the data parsing code 420 with the CPU. Once the data is separated from the header, the computer may store the data in data storage 426 and process the data by executing the application data processing code of application code 422.

The application code may be code configured under any one of a number of applications wherein data may be used, processed or otherwise consumed. These applications may be used as remote operations to the PDA, giving it extra processing power that can be performed by the computer. For example, the user of a PDA may wish to attach and send a document or other large data attachment to an email for transmission via the Internet. The PDA being limited in size and, consequently, limited in memory and data processing capacity, it would be a large burden for it to have the document stored and processed in the PDA. According to the invention, in response to a request sent from the PDA, a document stored on the computer is capable of being attached to an email and transmitted to an email recipient. The capacity of the computer may be utilized in numerous ways to offer expanded memory and processing capacity to the PDA remotely. This capacity may also be provided to the PDA by the communication interface 116. The interface may be equipped in the same manner as the computer as described herein to provide remote processing and data storage functions.

The computer may also include a database 428 containing data for use by the computer 126. According to the invention, the PDA may be able to access the database attached to the computer by sending data packets containing instructions to do so. Using this technique, the PDA is able to perform processing and transmission of data that would normally be burdensome to the PDA performing these tasks by itself.

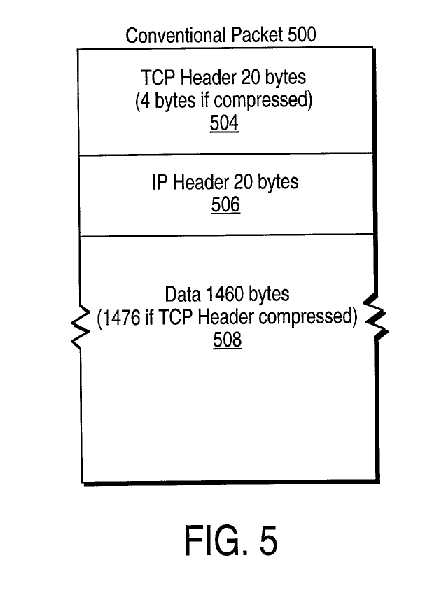

In operation, the presence of the communication interface allows the PDA to greatly simplify data transmission as well as computations that are regularly performed by the PDA in normal use. According to the invention, the communication interface also greatly expands the PDA's capabilities without requiring any improvements in processing capacity or data storage capacity. Referring to FIG. 5, an example of a data packet used in the prior art is shown. As can be seen, transferring data at 1500 bytes for each packet can take up to 44 bytes of space from the packet for the header alone, The PPP header 502 takes up 4 bytes, the TCP header 504 takes up to 20 bytes (4 bytes if compressed), and the IP header takes up 20 bytes, for a total of up to 44 bytes. If PPP encoding is used, the data packet is increased by approximately 300 more bytes, which may be required to be transferred with the encoded data. As discussed in the background, this lays a heavy burden on the PDA. In contrast, the data ID header 602 in the simplified packet takes up much less memory space, as little as 4 bytes for a packet of 1500 bytes in this example. This leaves much more data, 1496 bytes of data 604.

According to the invention, filtering out broadcast packets is also a useful method for reducing the amount of unnecessary data transmitted to the PDA. Again, since a typical PDA merely sends and receives packets, which typically occurs asynchronously, ongoing sessions are not required between a PDA and a network device. Therefore, data packets associated with network administrative functions need not be sent to the PDA. Such filtering reduces the processing and storage burdens on the PDA when communicating with a network device. Instead, the PDA may communicate with a network device directly, without the need to be associated with the network.

In normal operation, a PDA may communicate to devices on the network in different manners. According to the invention, the communication interface may simply relay data packets sent from the PDA to the network. It may also analyze the data packet for different purposes as it is transmitted through the interface. In either case, in one embodiment of the invention, the communication interface serves as a central conduit for communications between the PDA and network devices.

For example, a PDA may communicate with a particular network device by sending a message to the communication interface for relay transmission to the network device. In operation, the PDA may send one or more data packets to the communication device than includes the Internet protocol (“IP”) address of the network device. This transmission may be accomplished by transmitting a data packet having a TCP/IP/PPP protocol header, or another simplified header for transmissions between the PDA and the interface. The PDA may identify itself to destination devices by its own IP address. This way, packets may be sent in return. The interface may then transmit the packets to the network device using a TCP/IP protocol. This operation would pertain to a direct communication between a PDA and a network device.

As another example, a PDA may communicate to a number of devices connected to the network by multicasting or broadcasting a data packet or message to some or all network devices. This operation may be performed in the event of a PDA attempting to inform a plurality of network devices of certain information, the PDA's name or IP address for example. The PDA may also wish to find a network device that may be configured to transmit and receive data to and from the PDA, or that may authorize such communications.

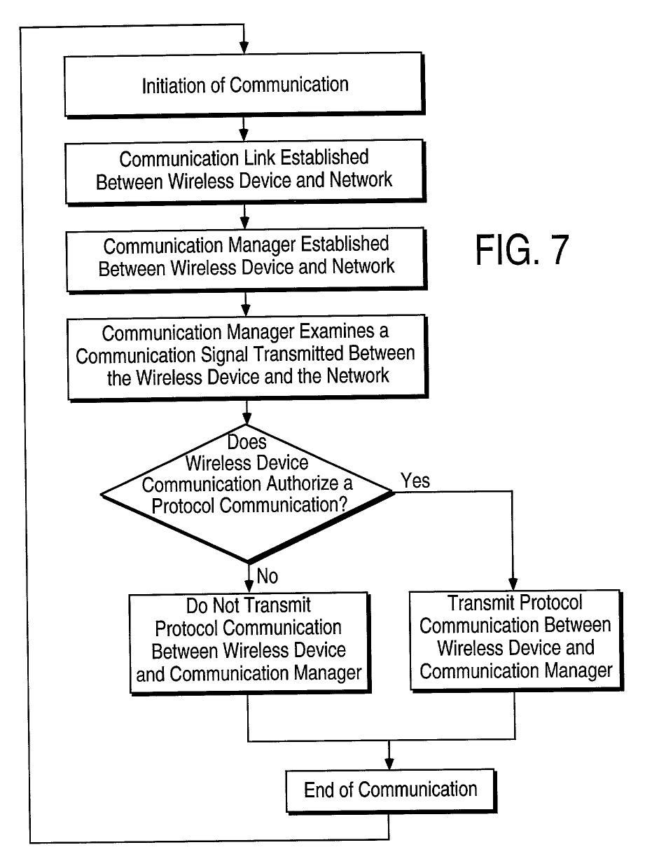

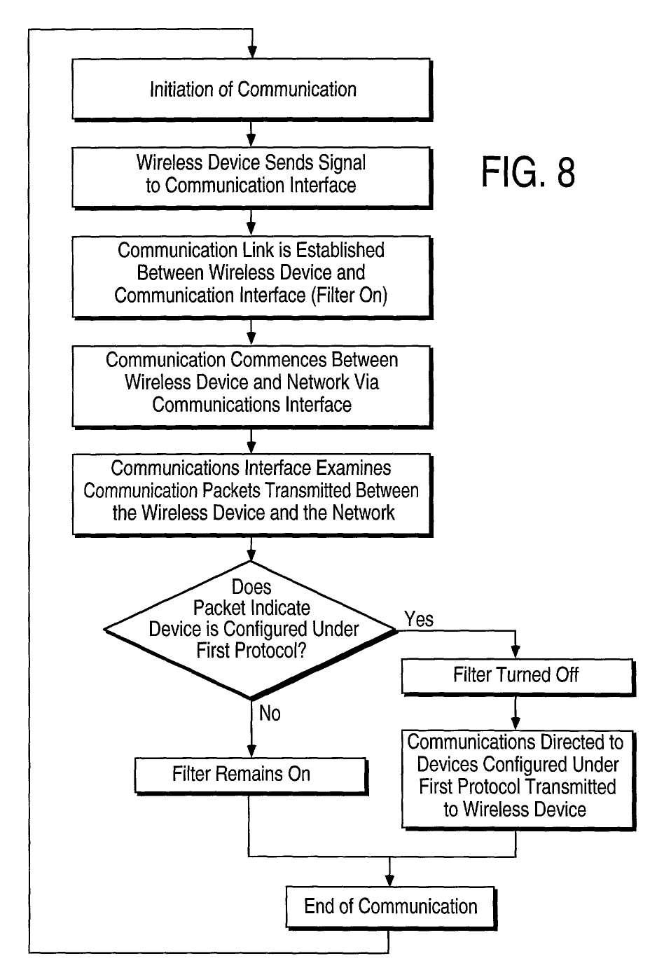

Referring now to FIGS. 7 and 8, further details of possible operations of a communication interface incorporating embodiments of the invention will be described. These figures illustrate the operations of different embodiments of the invention. However, this description of particular embodiments does not limit the scope of the invention, which is defined by the claims.

Referring first to FIG. 7, a method 700 of managing the communications between a wireless device and a device communicating with a network is illustrated. First, communication is initiated in step 702. However, in order for communication to occur between the wireless device and a device on the network via the communication interface, there must be at least two communication links established in step 704. One link must be established between the communication interface and the network. And another link must be established between the communication interface and the wireless device. Such links established between a communication interface and a wireless device is described in co-pending and commonly assigned U.S. patent application Ser. No. 09/733,312, entitled Method and Apparatus for Facilitating Communication between a Personal Data Assistant and a Computer, filed Dec. 8, 2000. Then, the communication can commence between the wireless device and a device on the network. In a preferred embodiment, the communication interface will initially have a real-time link established between it and the network. This allows TCP/IP communication with devices on the network. Initiating communication before this link is established is possible. However, having this link established before communication occurs with a wireless device allows for efficient communication between wireless devices and devices communicating with the network.

Still referring to FIG. 7, in step 706, a communication manager is established between the wireless device and the network. This manager may be a software application that parses out and examines data packets transmitted between a wireless device and the network. Some or all of the manager's functions may be implemented in hardware. However, for flexibility and efficiency, a preferred embodiment is implemented in software code. In one embodiment, the communication manager is embodied in a software application that is stored in the memory of the communication interface.

The communication manager, in step 708, is able to examine the communication signals transmitted between the wireless device and the network. In one embodiment, the communication manager is configured to detect one or more communication protocols used by wireless devices by examining the actual communications occurring between the wireless devices and the network. For example, in a Microsoft Windows network environment, an initiation process occurs between wireless devices requesting access to devices on the network and the network. This process occurs when new computers are added to the network, both wireless and hard-wired devices. Typically, a server receives this initiation signal and responds by initiating a naming routine in order to establish an identity for the device to distinguish the device from other devices communicating on the network. This is necessary to avoid communication conflicts within the network. The routine includes participation from every device that is active on the network. This gives each device the opportunity to identify whether a name has been given to an outside device that is already taken by a device connected to the network. Once a unique name has been established for the wireless device, it is network capable. It is now connected to the network and can communicate in the same manner as other devices on the network.

This naming routine is unfortunately burdensome if the wireless device happens to be a PDA. Moreover, it is unnecessary. Since PDAs simply send data packets, communication sessions are not necessary. Wireless devices, such as laptop computers that operate on a wireless link to the network, need to maintain a robust communication with a device on the network and may need ongoing and unbroken communication sessions. This is not the case for most conventional PDAs. If such communications are allowed to be transmitted to the PDA, being small in size and limited in processing power, the PDA may be overwhelmed by the naming routine. And, since every device participates in the naming process, so would any wireless device wishing to communicate within the network. Then, even after the naming process, the PDA would also need to participate in the naming routine whenever a new device is added to the network. The PDA would then be overwrought with having to receive and possibly respond to packets used in the naming routine, and would tie up valuable storage capacity and, more importantly, processing capacity. It is to this problem that one embodiment of the invention is directed. A communication interface configured with the invention would be able to protect the PDA from these overwhelming communications by not allowing the communication data packets to be transmitted to the PDA. The interface may be configured to examine every communication packet transmitted between the PDA and the network capable devices. This way, whenever a naming routing is occurring, the data packet transmissions are not sent to the PDA, leaving it to perform other valuable processes.

In step 710, the communication manager queries whether the wireless device authorizes a particular communication protocol, such as the naming routine. If it does not authorize such a protocol or routine, in step 712, the data packets pertaining to such communications are not transmitted to the wireless device. Such would be the case for a PDA rejecting, or not authorizing the transmission of naming protocols as discussed above. In the operation of one embodiment, a communication manager may be configured to relay particular data packets to the PDA. In such a configuration, incoming data packets may be examined for certain content and processed accordingly. If an unwanted data packet is received by the communication manager, it can be identified upon receipt and not forwarded to the PDA. For example, a data packet related to the Windows naming routing may be identified by examining the header of the packet. Once identified, the communication manager, properly configured, could simply not forward the packet to PDAs. The communication manager could, however, forward the naming packet to other wireless devices that authorize the transmission of such packets.

If the protocol is authorized for the wireless device, step 714 allows the communication interface to transmit the protocol communications to the wireless device. This allows devices in the network to send such communications to the Wireless device. Such would be the case for a wireless enabled laptop computer that wishes to fully participate as a network capable device, such as sending and receiving transmissions of data packets pertaining to the naming routine. The packet may be examined by the communication manager and identified as a packet pertaining to a naming routine. In this situation, the packet would be forwarded to the wireless device for processing.

In either case, once a transmission is complete, the communication manager may end the communication at step 716, returning to step 702 to wait for another initiation of communication. In a PDA, communications are typically asynchronous, and do not require an ongoing session. Therefore, for PDAs, the transfer of packets may need to initiate themselves upon each transmission. However, in a preferred embodiment, The steps of receiving and analyzing packets may include be one or more active or passive steps performed by the communication interface. In one embodiment, the communication manager may act as a filer and would send only packets that did not pertain to particular protocols. The ability to identify these protocols may be programmed into the communication manager. And, authorization to forward or the requirement not to forward such packets may be communicated to the communication manager from wireless device in different ways. On way would be to configure the communication manager to receive a command from a wireless device, indicating which types of data packages it is willing to receive and/or which types of packets it is not. This method, however, would require that both the communication device as well as every wireless device wishing to communicate with the network be configured to be compatible.

In a preferred embodiment, the communication manager is configured to derive the communication protocol from the actual data transmissions occurring between the wireless devices and the network devices. In protocols such as that used in the Windows naming routine, an initiation packet may be sent by a wireless device to initiate communication, beginning the naming routine. A properly configured communication manager could detect this initial communication packet or packets, giving the indication that the wireless device is a Windows network capable device. The communication manager could then allow all such naming packets to be relayed to the outside device. On the other hand, if the outside wireless device does not send out such a signal, it is a passive indication that it is not a Windows network capable device. The communication manager could be configured to then refrain from relaying naming or other similar packets to the outside device. The function of such a configuration is illustrated in the flow chart of FIG. 8. Upon initiation in step 801, communication links are established similarly as that discussed above in step 702, FIG. 7. In the next step 802, a wireless device sends a signal to the communication interface, which is destined for a device on the network, where the network is associated with the communication interface. A communication link is then established between the wireless device and the communication interface in step 804.

In this method, the communication manager may act as a filter when enabling the transmission of data packets between the wireless device and devices connected to the network. In operation, the filter is normally on from the beginning of communication with the wireless device. This way, if a PDA initiates communication with the communication interface, intending to communicate with devices connected to the network, it will not be bombarded with unwanted data packets, such as those sent in connection with the Windows naming routine. Communication may then commence between the wireless device and the communication interface in step 806, with the interface filtering out certain data packets by default. The filter may remain on until otherwise turned off. The communication packets may then be examined by the communication interface in step 808, which may include a communication manager as discussed above. In step 810, the communication interface determines whether a device is configured under a predefined first protocol; such as a Windows network protocol known as NetBeui discussed above. If it is not, then the process proceeds to step 812 and the filter remains on until the end of the communication. This would be the case, for example, of a PDA that is not configured under the Windows network protocol. Data packets, such as broadcast naming packets would be filtered out and not relayed to such a PDA. Since ongoing sessions are not required by a PDA, simple, often asynchronous, transmission of data between the PDA and network devices are sufficient for the PDAs operation.

If, however, the device communicates with the communications interface by sending an initiation packet that indicates that the device is configured under the first protocol, then the filter is turned off in step 814, allowing protocol related packets to be relayed to the wireless device in step 816. Then, communications directed to devices configured under the first protocol would be relayed to the wireless device. A laptop computer is an example of such a device. Such a device would likely require an ongoing communication session with devices on the network in order to fully take advantage of the network features. The filter would remain off until the end of a communication session in step 818, or upon another event that may be defined and configured within the communication interface.

For either type of device, the communication link with the communication interface continues until the end of communication or upon some other termination. For example, a PDA may want to maintain an asynchronous link so that it does not need to complete an initiation process each time it sends a packet. In such a configuration, the communication interface can keep a log of the device identification and allow packets to be relayed to the outside device. In the case of a PDA, the filter may remain on, filtering out unwanted data packets. In the case of a laptop computer, the filter would remain off, allowing such communications.

The invention may also enable the management of communications among devices communicating in different spoken languages. For example, devices may exchange text in two or more languages, giving the communication interface criteria for which to base the transfer of certain data packets. In such an embodiment, the communication manager could be configured to parse out the text information from within transmitted data packets. The device could then determine which language the text is written. This process may be similar to the manner in which the communication manager would determine whether a device is configured under a Windows network protocol as discussed above. This configuration would be very useful in a network used by users that communicate in other languages. Translation software could be used to provide textual representations in multiple languages. For example, a device connected to the network could be configured to transmit multiple versions of a text document in different languages. The communication manager may be configured to examine each packet and identify the language in which the text is written, and send it to participating PDA users.

The invention provides a method and apparatus is provided for facilitating communication between a wireless device, such as a PDA or a laptop computer and disparate devices or systems. A device is provided that is configured to receive and examine data packets transmitted between a wireless device and a device that communicates with a network. In operation, based on information in the data packet, if the data packet is configured under a first protocol, the communication device is configured to filter out the certain data packets transmissions to particular wireless devices, such as PDAs. If the communication device is not configured under the first protocol, such as a laptop computer, the communication device is configured to transmit the all data packets destined for the wireless device. The inclusion of such a communication interface in a computer system reduces the amount of overhead data required to send data to and from the PDA, and also reduces the amount of computation required of the PDA to receive and transmit the data. Another embodiment of this configuration also allows a PDA to utilize remote devices in order to extend its processing power. Although this embodiment is described and illustrated in the context of the use and operation of a PDA, the scope of the invention extends to other applications where convenient and efficient data transmission is desired. Furthermore, while the foregoing description has been with reference to particular embodiments of the invention, it will be appreciated that these are only illustrative of the invention and the changes may be made to those embodiments without departing from the principles of invention, the scope of which is defined by the appended claims.

1. For use in a communication interface for communication between a wireless device and the communication interface, the communication interface being configured to communicate with other devices communicating with a network and configured to facilitate data communication between the wireless device and other devices connected to the network, a computer readable medium having stored thereon a plurality of sequences of instructions, said sequences of instructions including instructions that, when executed by a processor, cause said processor to perform the steps of:
receiving an initialization packet from a wireless device;
establishing a communication link with the wireless device;
establishing another communication link between the wireless device and the network; and
managing the transmission to the wireless device of authorized communication signals sent from the computer system by:
receiving and analyzing signals when received; and
transmitting authorized signals to the wireless device according to the communication protocol.

2. A method according to claim 1, wherein the managing of the transmission includes:
examining data packets transferred between a wireless device and a network device;
determining which signals are authorized for transmission to the wireless device according to a first communication protocol; and
if the examination of a data packet indicates that the wireless device has authorized the transmission of authorized communications to the wireless device, transmitting a data packet to the wireless device
if the examination of a data packet indicates that the wireless device has authorized the transmission of authorized communications to the wireless device, transmitting a data packet to the wireless device.

3. A method according to claim 1, wherein the managing of the transmission includes:
examining a data packet transferred between a wireless device and a network device;
determining whether the data packet is authorized for transmission to the wireless device according to a first communication protocol; and
if the examination of a data packet indicates that the wireless device has authorized the transmission of particular communications to the wireless device, transmitting a data packet to the wireless device;
if the examination of a data packet indicates that the wireless device has not authorized the transmission of particular communications to the wireless device, not transmitting a data packet to the wireless device.

4. A method according to claim 1, wherein the managing of the transmission includes:
examining a data packet transferred between a wireless device and a network device;
determining whether the wireless device is configured to communicate under a first protocol, wherein the first protocol dictates whether a data packet is authorized for transmission to the wireless device; and
if the examination of a data packet indicates that the wireless device is configured under the first protocol, transmitting a data packet to the wireless device;
if the examination of a data packet indicates that the wireless device is not configured under the first protocol, not transmitting a data packet to the wireless device.

5. For use in a communication interface for communication between a wireless device and another device via the communication interface, the communication interface being configured to communicate with other devices communicating with a network and configured to facilitate data communication between the wireless device and other devices connected to the network and to filter out certain communications from reaching the wireless device, a computer readable medium having stored thereon a plurality of sequences of instructions, said sequences of instructions including instructions that, when executed by a processor, cause said processor to perform the steps of:
receiving a data packet transmission between a network affiliated device and a wireless device;
analyzing the data packet when received;
determining whether the data packet contents indicate whether the wireless device is configured to accept session data packets from a network device;
if the wireless device is configured to accept session data packets from a network device, transmitting session data packets to the wireless device..

6. A method according to claim 5, wherein the communication interface determines whether a wireless device is configured to receive Windows network communications protocol by:
examining data packets transmitted from the wireless device to the network device;
if the data packet does not include an indicia that may be used to identify the wireless device as a Windows network compliant device, filtering Windows network protocol data packets from transmission to the wireless device; and
if the data packet includes an indicia that may be used to identify the wireless device as a Windows network compliant device, allowing Windows network protocol data packets to be transmitted to the wireless device.

7. For use in a communication interface for communication between a personal data assistant (PDA) and the communication interface, the communication interface being configured to communicate with other devices communicating with the internet and configured to facilitate data communication between the PDA and other devices, a computer readable medium having stored thereon a plurality of sequences of instructions, said sequences of instructions including instructions that, when executed by a processor, cause said processor to perform the steps of:
receiving an initiation packet from a computer system that is intended to be broadcast to devices outside the network;
receiving communications signals from devices outside the network that identify outside devices;
determining which outside devices are configured as network devices by analyzing the communication signals sent by such devices that are capable of communication with devices associated with the network;
sending the broadcast initiation packet to outside devices that are identified as network devices; and
filtering the broadcast initiation packet from outside devices that are identified as PDA devices to prevent the broadcast initiation packet from being transmitted to the PDA.

8. A communication interface for managing communication between a wireless device and a network device comprising:
a receiver configured to receive data packets received by the communication device, the receiver including a signal receiver configured to receive a signal used for transmitting data over a medium and converter configured to convert the data signal into a form that can be stored;
a transmitter configured to transmit data packets over a medium;
a storage device configured to store data, the storage device including a storage mechanism for storing data packets received by the receiver;
an analyzer configured to examine data packets transmitted between a wireless device and a network device; and
a filter mechanism configured manage data transmissions between the wireless device and the network device.

9. A communication interface according to claim 8, wherein the analyzer includes an identifier that is configured to identify a data packet sent by a particular wireless device that is configured according to a first protocol, and wherein the filter mechanism is configured to subsequently relay data packets that are sent by a network device that are configured according to the first protocol to the particular wireless device in response to the analyzer receiving a data packet sent by the particular wireless device.

10. A communication interface according to claim 8, wherein the analyzer is configured to identify a data packet sent by a wireless device that is configured according to a first protocol, and wherein the filter mechanism is configured to subsequently relay data packets to the wireless device that are sent by a network device and that are configured according to the first protocol.

11. A communication interface according to claim 8, wherein the analyzer includes an identifier that is configured to identify a data packet transmitted by a wireless device that indicates that the transmitting wireless device is configured according to a first protocol, and wherein the filter mechanism is configured to subsequently relay data packets that are sent by a network device that are configured according to the first protocol only to wireless devices that have transmitted such a packet having such indicia.

12. A communication interface for affecting communication between a wireless device and a network device comprising:
receiver means for receiving data packets;
converter means for converting the data signal into a form that can be stored;
transmission means for transmitting data packets over a medium;
storage means for storing data packets;
examining means for examining data packets transmitted between a wireless device and a network device; and
filter means for filtering our data transmissions between the wireless device and the network device upon a condition

13. A communication interface according to claim 12, wherein the examining means is configured to identify a data packet configured according to a first protocol that is transmitted by the wireless device, and wherein the filter means is configured to subsequently relay data packets that are sent by a network device and that are configured according to the first protocol to the particular wireless device in response to the examining means transmitting a data packet sent by the wireless device.

14. A communication interface according to claim 12, wherein the examining means is configured to identify a data packet sent by a wireless device that is configured according to a first protocol, and wherein the filter means is configured to subsequently relay data packets to the wireless device that are sent by a network device and that are configured according to the first protocol.

15. A communication interface according to claim 12, wherein the examining means is configured to identify a data packet transmitted by a wireless device that indicates that the transmitting wireless device is configured according to a first protocol, and wherein the filter means is configured to subsequently relay data packets that are sent by a network device that are configured according to the first protocol only to wireless devices that have transmitted such a packet having such indicia.

16. A system for communicating between a wireless device and a network device comprising:
an electronic wireless device configured to communicate with other electronic devices according to a communication protocol;
an electronic network device configured to communicate with other electronic devices via a computer network;
a communication interface having a receiver configured to receive data packets, the receiver including a signal receiver configured to receive a signal over a transmission medium and a converter configured to convert the data signal into a form that can be stored; a transmitter configured to transmit data packets over a medium; a storage device configured to store data, the storage device including a storage mechanism for storing data packets received by the receiver; an analyzer configured to examine data packets transmitted between the wireless device and the network device; and a filter mechanism configured manage data transmissions between the wireless device and the network device.

17. A communication interface according to claim 16, wherein the analyzer includes an identifier that is configured to identify a data packet sent by a particular wireless device that is configured according to a first protocol, and wherein the filter mechanism is configured to subsequently relay data packets that are sent by a network device that are configured according to the first protocol to the particular wireless device in response to the analyzer receiving a data packet sent by the particular wireless device.

18. A communication interface according to claim 16, wherein the analyzer is configured to identify a data packet sent by a wireless device that is configured according to a first protocol, and wherein the filter mechanism is configured to subsequently relay data packets to the wireless device that are sent by a network device and that are configured according to the first protocol.

19. A communication interface according to claim 16, wherein the analyzer includes an identifier that is configured to identify a data packet transmitted by a wireless device that indicates that the transmitting wireless device is configured according to a first protocol, and wherein the filter mechanism is configured to subsequently relay data packets that are sent by a network device that are configured according to the first protocol only to wireless devices that have transmitted such a packet having such indicia
